(19) United States
(12) Patent Application Publication
(10) Pub. No.: US 2015/0046469 A1
(43) Pub. Date: Feb. 12, 2015

(54) CONTENT RETRIEVAL AND REPRESENTATION USING STRUCTURAL DATA DESCRIBING CONCEPTS

(71) Applicants: Matti Koskinen, Helsinki (FI); Eetu Laaksonen, Vantaa (FI); Jussi Lahtinen, Helsinki (FI); Vladimir Poroshin, Helsinki (FI); Antti Tuominen, Helsinki (FI); Kimmo Valtonen, Helsinki (FI)

(72) Inventors: Matti Koskinen, Helsinki (FI); Eetu Laaksonen, Vantaa (FI); Jussi Lahtinen, Helsinki (FI); Vladimir Poroshin, Helsinki (FI); Antti Tuominen, Helsinki (FI); Kimmo Valtonen, Helsinki (FI)

(73) Assignee: M-BRAIN OY, Helsinki (FI)

(21) Appl. No.: 14/126,963

(22) PCT Filed: Jun. 17, 2011
(86) PCT No.: PCT/FI2011/050584

§ 371 Date: Sep. 24, 2014

(51) Int. Cl. G06F 17/30; G06F 17/28

(52) U.S. Cl. CPC G06F 17/3053; G06F 17/30386; G06F 17/289
USPC 707/748; 707/758

(57) ABSTRACT

A method for retrieving and representing media items in a communication network having a plurality of media items. In the embodiment, first at least one media item is retrieved from the communication network. Then, said retrieved media item is normalized. After normalizing, said retrieved media item is classified over a set of concepts, where each concept is associated with at least one description. Later, this classified media item may be compared with a description of information need.

### FIELD OF THE INVENTION

The invention relates to retrieving and representing the results of searching for data, e.g. text from the Internet. In particular the present invention relates to representing information extracted from a preselected set of data.

### BACKGROUND OF THE INVENTION

The number of websites and the volume of the material they contain have grown rapidly in recent years. At the same time the content in the websites has become more extensive and it evolves on a daily basis. Today most of the companies selling products or services have a website describing their business. In addition to these business related websites the Internet is full of different non-business websites. In addition to the fast growth in the number of websites, the content in these websites has become more diverse. In addition to ordinary documents, media items stored in the websites include images, video clips, sounds and other similar media items. Because of this it is sometimes hard to find the data that is being searched. This problem has been addressed not only by making better search engines, but also by making better ways of representing the results of the search engines.

Customers having a need to discover information relevant to their business, especially as a sequence of events evolving over time, have not been able to meet their requirements with the prior art systems. Meeting this need through keywords and query terms is cumbersome, as one needs to arrive at a sufficient set of keywords, and the use of logical and proximity operators requires expertise. If the information needs to be gathered over several languages, the problem worsens, as in a typical realistic set-up linguistic skills are required for a number of languages beyond average personal knowledge. The one-to-many nature of translation adds further complexity.

A further drawback of the prior art is insufficient Net-scalability of the chosen representation. For example, an arbitrarily large content collection, say, an entire web site, has to be summarizable. This causes an increased need for data storage, as in the prior art the description of each document is a set of all the (meaning-carrying) words occurring in it. A further drawback of the prior art is that by using query word based descriptions of the results of harvesting (data collection) as the representation of an information need, it is very difficult to show the similarity and dissimilarity of N different information needs over time.

### SUMMARY

The purpose of the present invention is to provide a method for having a Net-scalable means of representing media-based information based on a similarity score operating both on descriptions of sets of media items and on descriptions of information needs, for example, desired characteristics of the media items.

The score itself operates upon auto-semantics in addition to established Information Retrieval metrics. The auto-semantics can be either monolingual, wherein all media item content and information needs are described using a single language, or cross-lingual, wherein the set of languages used in media items or information need definitions is arbitrary.

The above mentioned purpose is achieved by arranging the source data according to the present invention. This facilitates better search results, a possibility for intuitive visualization of the search results and transparent ranking of the search results.

In an embodiment the invention is implemented as a method for searching for and representing media items in a communication network having a plurality of media items. In the embodiment, first at least one media item is retrieved from the communication network using a specific harvesting method. Then, said retrieved media item is normalized. In the present application, normalization means conversion of the original data to a version where non-meaningful features of the data are removed or transformed. In the case of natural language text, this means tokenization, non-token removal, lemmatization, machine translation and other means of preprocessing data in text-based Information Retrieval. After normalizing, said retrieved media item is classified over a set of concepts, where each concept is associated with at least one description of said concept.

In a further embodiment, after classifying, a description over the set of concepts of the information need is received, and said concept-classified media items are matched with the received conceptual description of the information need.

In an embodiment of the invention the received conceptual description of the information need comprises favored concepts and disfavored concepts. In a further embodiment of the invention said descriptions are associated with a concept are in several different languages. In a further embodiment of the invention said retrieved media item is machine translated during the normalization of said media item.

In an embodiment of the invention a subset of descriptions based on said matching is provided for further embodiments. Said subset may be visualized, wherein the visualization step comprises scoring for similarity and providing a similarity matrix based on said scoring. The dimensionality of the similarity matrix may be reduced before visualization. In a further embodiment of the invention said subset of descriptions is ranked in order of relevancy with regard to the information need.

In an embodiment the present invention is implemented as computer software. The software is preferably executed in a server that is connected with client computers.

In an embodiment of the invention the information is media-based business intelligence. In this application media-based business intelligence means the branches of business data analysis that operate on media content, using it as a proxy for the market, consumer opinion, evolution of the industry and competitors'actions.

The present invention has a plurality of benefits. The most important benefit is that the search results are particularly informative when the actual search is based on the descriptions instead of the actual documents.

A further benefit is that the present invention enables matching candidate media content for relevance against an information need more directly and transparently than in methods where an intermediate language, such as a traditional query language, needs to be introduced as a clumsy proxy. As a by-product, the method will allow using example content as the only description of an information need.

A further benefit is improved Net-scalability with respect to presentational scalability. An arbitrarily large content collection, for example an entire web site, needs from the point of view of Business Intelligence to be summarizable in an arbitrarily compact fashion using the chosen representation, and for practical reasons it is not feasible to store in full the content in the case where it does not match the current information need of any customer. In such a case of no match, only an arbitrarily succinct description capturing the content needs be stored, allowing re-evaluation of content relevance if a new information need matches that small-space high-level description. Probably relevant material can then be harvested from the known source(s) dynamically.

A further benefit is the ability to show the similarity and dissimilarity of N different information needs over time in an intuitive representation that makes the detection, recognition and study of the evolution of any differences efficient and clear. For example, company X wants to compare the evolution of the social media discussion around their product P1 against the discussion over product P2 of their competitor Y. With the prior art methods, this cannot be done in a way that allows instant perception.

A further benefit of the invention is that machine translation during normalization works particularly well. Thus, searches can be directed to a wider scope of media items and the person making the search receives better search results as the search scope comprises documents in multiple languages.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a flow chart of an example embodiment according to the present invention, and

FIG. 2 is a block diagram of an example embodiment of the present invention.

### DETAILED DESCRIPTION OF THE INVENTION

Reference will now be made in detail to the embodiments of the present invention, examples of which are illustrated in the accompanying drawings.

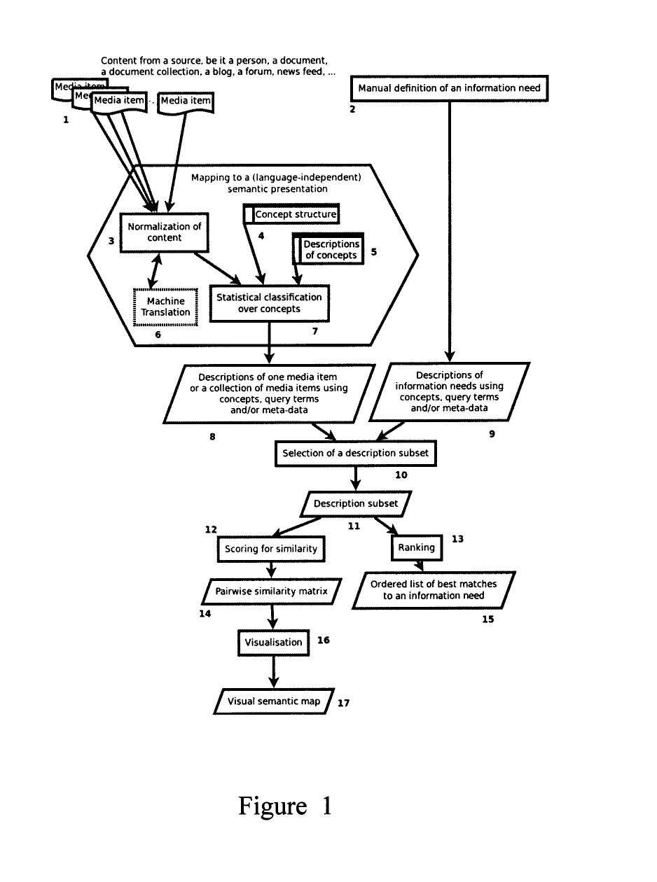

In FIG. 1 a flow chart of an example embodiment according to the present invention is disclosed. In FIG. 1 a plurality of media items 1 are used. The relevant media items are selected based on a manually defined information need 2. According to the present embodiment, at least one media item is normalized, step 3. The media item may be machine translated during normalization, step 6. The semantics of the content of each media item 1 are determined in a supervised setting where the method is given associations of concept names and content describing them, step 5, either in one or in several languages. The concepts form a hierarchy, which is typically an acyclic graph, where each concept may have several parents and several children 4.

The technical goal is then to have first of all a commensurate representation 8, 9 for both the information need 2 and for the content of the media items 1. The description of information need 9 has to be a natural and intuitive way of meeting the customer's requirements in all of the cases described above. The main goal is interoperability, i.e. that measuring the similarity of descriptions either across or within description types 8,9 is achieved using the same set of operations. The priority lies on the ease of describing 9 an information need 2 precisely, not on the ease of describing 8 the media content 1.

The chosen core representation, the descriptive language, is one or more weight vectors over a set of concepts. The concepts themselves form an acyclic graph, and each concept is associated with descriptions in one or several languages. Reasons for allowing more than one weight vector arise naturally from the fact that the user knows not only what they want but also what they do not want, and these needs require separate weights. Furthermore, the content of a media item 1 can be described at several levels, for example, the content around the keywords, if any are used, vs. the content of the entire item, etc. The present invention describes a method to represent any content in this way. For the nature of the content, the invention does not set any other limit except that it should be describable as a distribution over a set of features, in the present embodiment as a distribution over the occurrence of words in the content of a natural language text type. The method is in principle just as applicable to other types of content such as images, as long as a suitable feature set is used.

In the following the process for producing descriptions is described. The semantics of the content of each media item 1 are determined in a supervised setting where the embodiment is given associations of concept names and content describing them 5, either in one or in several languages. The concepts form a hierarchy, typically an acyclic graph, where each concept may have several parents and several children 4. There may exist a number of graphs for several languages and several graphs within a single language for particular purposes (e.g. the customer is only interested in a particular domain and its particular subdivision). The embodiment can utilize any suitable method for classifying suitably normalized content 3 over the set of all possible concepts, given the aforementioned type of training data, for example, a TF-IDF (term frequency-inverse document frequency) based method where the query is the contents of the media item as in the current prototype, or some other classifier such as a supervised Bayesian Network, a support vector machine, etc.

Given the classification over all concepts 7, resulting in a predictive score for each concept, a further cross-lingual mapping stage may follow in several possible setups, given a target language for the concept names. In an example of a setup the content of the media item is Machine Translated into the target language 6 and then the monolingual classification model for that language is used. In a further example of a setup the monolingual classification model for the original language is used, if one exists (if suitable training data is available) and then the result is mapped to the chosen concept graph. For the mapping, inter-graph links may exist, as in the prototype. In a further example of a setup the content of each media item is mapped to a superstructure over all existing language versions of the chosen concept graph in parallel. The setups mentioned above may be combined with each other.

After this, a smoothing step follows, where the distribution over the concept graph(s) is smoothed by spreading the predictive mass to the neighborhood of any node that received a significant amount. The amount of spreading may be controlled by the similarity of adjacent nodes, for example, the more similar their description, the more of the mass is spread. The similarity may be determined by the same means as above or by independent means, chosen to avoid over-fitting. The motivation is to prevent over-smoothing, as the data typically displays occasionally large divergence in this sense as the ancestor of a node has only a weak connection to it in semantic terms, the reason being that the concept graph is in practice likely to be only a sample of the “true” concept space, even in the approximately 4 000 000 concept size space of the prototype. Note also that the invention takes the view that the set of concepts is not closed. The amount of smoothing is controlled by a parameterized method.

As the concepts form a hyponymy graph, the resulting mapping can then in an additional stage be mapped to a more general representation via a clustering method, if this suits the use case, for example if the information need of the customer is best describable at an abstract level, for example, “give me all politics-related content”.

Once each media item has been mapped to the concept graph, the resulting arbitrarily high-dimensional (in the order of millions) vector representation is then sparsified suitably, for example depending on scalability and performance issues, and provided as input to the stage of matching against information needs 10.

In the following two examples of uses of the above described searching method are disclosed. In the first example the user can define a particular type of information need 2 to reflect the specific use case of ranking for relevance one-dimensionally. This kind of an information need actually consists of two definitions, one for the concepts that the user knows a priori that they want to favor, and one for the concepts that the user a priori knows they want to disfavor 9.

Once the user has defined these two aspects as two separate distributions over the concept graph 9, however, either one may be missing. The re-ranking can be done by a function over all media items. The function scores each item's description 8 for similarity both to the positive distribution and to the negative distribution 9. Once these similarities have been measured, the overall ranking score for the item 13 is a further function of these scores and the original ranking score 10,11. This latter stage is done both to smooth the result in an intuitive fashion, and to maintain coherence in the areas where neither the positive nor the negative profile matches to any significant degree. In the current prototype the first stage is a dot product, the second one a linear combination with an heuristic weight vector. The re-ordered results are then shown to the user as a one-dimensional list 15 as in the traditional Information Retrieval.

In the second example the sparsified matrix of weights over concepts, describing the contents of each media item, acquired through 10,11 and 12, is fed into a visualization method, which performs similarity scoring 12 with a matrix as the outcome 14, and then dimensionality reduction into a low-dimensional representation 16, wherein the number of dimensions is typically two or three. Any suitable method, for example, Sammon mapping, can be used for this. The time aspect and the mapping to the concept structure are key features, as the user interface can then display in the visualization 17, for example, emergent patterns over time and over media types, languages and other media-based Business Intelligence-relevant aspects and scatter plots over two semantic features which themselves can be arbitrary distributions over the concept graph.

Scalability beyond hundreds of hit documents can be obtained by first clustering the documents prior to visualizing them, up to hundreds of clusters or whatever the limits imposed by usability concerns and the particular display method or user interface, and then passing the resulting centroids as input to the visualization method. This can be done on an arbitrary number of levels. The user interface can then allow the characterization and study of each cluster in detail, when so desired.

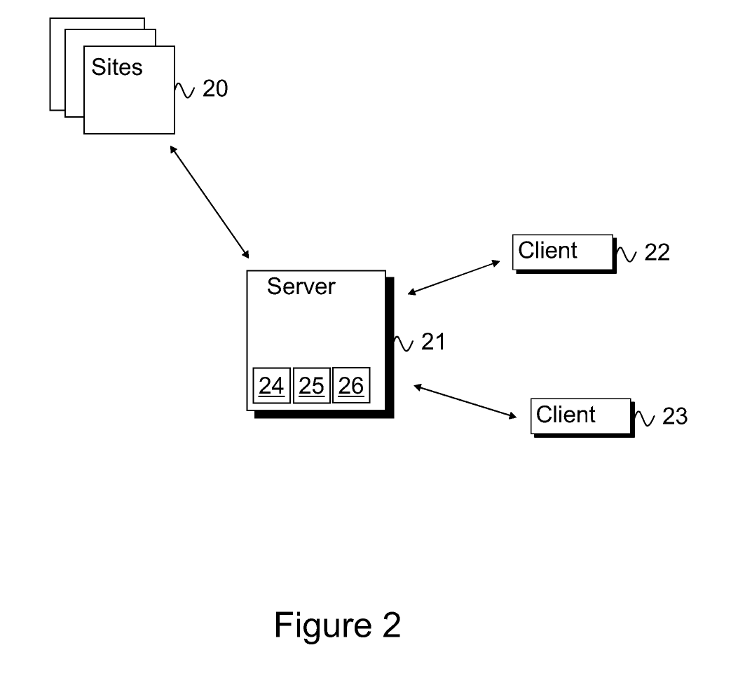

FIG. 2 discloses a block diagram of a system according to the present invention. In FIG. 2 media items are stored in a plurality of websites 20.

A server 21 is connected to these websites by using data communication means 24 such as an Internet connection. The server 21 further comprises at least one processor 25 and storage means 26. At least one processor 25 is configured to perform the method disclosed above. Storage means 26 are configured to store the concepts, associated descriptions and other data related to the invention as desired. In FIG. 2 two client machines 22 and 23 are disclosed. They may be ordinary computers, mobile devices or other suitable client devices. It is common that the client devices use the functionality at the server. However, it is possible to implement the invention as a client software product or as an independent stand-alone software product.

In an embodiment of the invention the invention is implemented as computer software that is configured to execute the method and independent features described above when the computer software is executed in a computing device. The computer software may be embodied in a computer readable medium or distributed in a network such as the Internet.

It is obvious to a person skilled in the art that with the advancement of technology, the basic idea of the invention may be implemented in various ways. The invention and its embodiments are thus not limited to the examples described above; instead they may vary within the scope of the claims.

1. A method for searching media items in a communication network having a plurality of media items which method comprises:
retrieving at least one media item from the communication network;
normalizing said retrieved media item, wherein normalizing said retrieved media item further comprises machine translation of said media item; and
classifying said retrieved media item over a set of concepts, wherein each concept is associated with at least one description.

2. The method according to claim 1, wherein the method further comprises:
receiving a conceptual description of the information need;
matching said classified media items with the received conceptual descriptions of the information need.

3. The method according to claim 2, wherein the received conceptual description of the information need comprises favored concepts and disfavored concepts.

4. A method according to claim 1, wherein said at least one description associated with a concept is in several different languages.

5. (canceled)

6. A method according to claim 2, wherein the method further comprises providing a subset of descriptions based on said matching.

7. A method according to claim 6, wherein the method further comprises visualization of said subset.

8. A method according to claim 7, wherein said visualization comprises scoring for similarity and providing a similarity matrix based on said scoring.

9. A method according to claim 8, wherein the method further comprises reducing the dimensionality of said matrix.

10. A method according to claim 6, wherein the method further comprises ranking said subset of descriptions in order of relevancy with regard to the information need.

11. A method according to claim 1, wherein the method further comprises storing said retrieved media items or descriptions relating to said retrieved media items.

12. A computer program wherein the computer program is configured to perform the method according to claim 1 when executed in a computing device.

13. A server for searching media items in a communication network having a plurality of media items, which system further comprises:
data communication means for receiving and transmitting data;
a processor for processing received data; and storage means for storing media items;
characterized in that the system is configured to perform the method according to claim 1.

14. (canceled)

15. A system for searching media items in a communication network having a plurality of media items, the system comprising:
data communication means for receiving and transmitting data;
a processor for processing received data; and
a storage means for storing media items;
wherein the system executes a computer program associated with a computer device, the computer program retrieving at least one media item from the communication network, normalizing the retrieved media item by machine translation, and classifying the retrieved media item over a set of concepts, wherein each concept is associated with at least one description.
